(19) United States
(12) Patent Application Publication
(10) Pub. No.: US 2010/0159277 A1
(43) Pub. Date: Jun. 24, 2010

(54) Bilayer protection coating and related method

(75) Inventors: David V. Bucci, Simpsonville, SC (US); Kathleen B. Morey, Scotla, NY (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/902,423

(22) Filed: Sep. 21, 2007

(51) Int. Cl. B32B 15/01; B05D 1/36; C23C 28/02; C23C 4/08; C23C 4/12

(52) U.S. Cl. 428/686; 427/405; 205/191; 427/456; 427/449

(57) ABSTRACT

A turbine component having a protective bilayer coating thereon comprising: a superalloy substrate; and a bilayer protective coating applied to the substrate wherein the bilayer protective coating comprises a first inner layer of platinum and aluminum; and a second outer oxidation-resistant layer applied over the first inner layer, the second outer layer comprising an MCrAlX alloy where M is selected from Fe, Ni and Co, and where X is yttrium or another rare earth element. A method of improving oxidation resistance of a Ni or Co-based superalloy turbine component comprising: depositing a bilayer protective coating on a turbine component by depositing a first inner platinum-aluminum layer on a surface of the turbine Component; and depositing a second outer layer comprising an MCrAlX alloy over the first inner layer, wherein M is a metal selected from Fe, Ni and Co, and X is yttrium or another rare earth element.

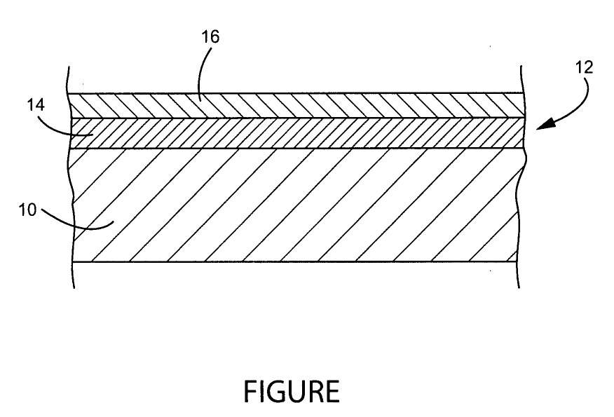

### BACKGROUND OF THE INVENTION

This invention relates to gas turbine engine technology generally, and specifically to protective coatings for turbine components exposed to harsh conditions.

Gas turbine engines run in extreme temperature environments. The nickel and cobalt-based superalloys of which many of the hot gas path components are composed, are exposed to harsh conditions where either oxidation or corrosion damage may penetrate into the superalloy substrate. Components damaged in this manner must be removed and repaired before returning the components to service. The repair process, however, reduces the wall thickness of the part and ultimately the life of the component.

### BRIEF DESCRIPTION OF THE INVENTION

In an exemplary but non-limiting embodiment, there is described herein a bilayer coating comprised of an inner layer of diffused PtAl (or PdAl), and an outer oxidation-resistant layer that is applied over a nickel or cobalt-based superalloy substrate. This arrangement protects the base superalloy component from oxidation and corrosion as described further herein.

More specifically, the inner PtAl (or PdAl) diffused layer is produced in two steps. First, the Pt is deposited by a method such as electroplating, painting or slurry methods, followed by deposition of the aluminum by a vapor phase or other suitable process. The outer oxidation-resistant layer is comprised of an MCrAlY alloy as well as other additive elements (X), where M is selected from Fe, Ni and Co, sprayed over the diffused inner layer, and X is selected from one or more of oxidation enhancing elements.

The addition of an inner PtAl (or PdAl) diffused layer, between the outer oxidation-resistant layer and the Ni or Co-based superalloy substrate, serves to slow diffusion of aluminum from the outer oxidation-resistant layer into the nickel or cobalt-based substrate. This is important because diffusion of aluminum from the outer oxidation-resistant layer into the substrate reduces the ability of the outer layer to fight oxidation. By slowing the diffusion of aluminum into the substrate or superalloy base, the rate of oxidation and corrosion of the substrate is slowed, thereby increasing part life.

Accordingly, a bilayer protection layer is disclosed herein which comprises a turbine component having a protective bilayer coating thereon comprising: a superalloy substrate; and a bilayer protective coating applied to the substrate wherein the bilayer protective coating comprises a first inner layer of platinum (or palladium) aluminide; and a second outer oxidation-resistant layer applied over the first inner layer, the second outer layer comprising an MCrAlX alloy where M is selected from Fe, Ni and Co, and X is selected from the rare earth elements.

In another aspect, the invention relates to a method of a method of improving oxidation resistance of a Ni or Co-based superalloy turbine component comprising: depositing a bilayer protective coating on a turbine component by creating a first inner diffused platinum-aluminide (or palladium aluminide) layer on a surface of the turbine component; and depositing a second outer layer comprising an MCrAlX alloy, wherein M is a metal selected from Fe, Ni and Co, and X is selected from the rare earth elements.

The invention will now be described in connection with the single drawing FIGURE identified below.

### BRIEF DESCRIPTION OF THE DRAWING

The single drawing FIGURE is a schematic cross-section of a bilayer protective coating over a superalloy turbine component substrate.

### DETAILED DESCRIPTION OF THE INVENTION

With reference to the single drawing FIGURE, the substrate 10 may be part of any gas turbine component, and particularly a hot gas path component subject to extreme temperature environments. The component substrate in the exemplary embodiment is a nickel or cobalt-based superalloy typically used for such components. A bilayer coating 12 is applied over the substrate 10 to provide protection from damage due to oxidation and corrosion.

A first inner layer or bond coat 14 of the coating 12 may be comprised of platinum (or palladium) aluminide (PtAl or PdAl), i.e., a PtAl or PdAl diffused aluminide coating layer. The platinum (or palladium) component is deposited first by any suitable process such as electroplating, paint or slurry methods. The aluminum component of the inner layer 14 is preferably applied in aluminide form, by vapor phase (above the pack vapor or chemical vapor deposition (CVD)) techniques, or pack powder techniques. In these processes, Si, Hf, Re, Ru, Ge, Pt, Pd, Ta or any other suitable known oxidation enhancing elements may be added to reduce or slow down scale formation. This can be done by plating on the part before the aluminide or mixed into the aluminide, either in powder form or in a slurry, or added to the vapor (above the pack or CFD). There are also Al or Al+ tapes that can be placed on the surface of a part (all or a part thereof) and diffused. In addition, the Al or Al+ can be sputtered on the part and then diffused.

After the inner diffused aluminide layer 14 has been provided on the substrate 10, an outer protective (oxidation-resistant) layer 16 of the coating 12 is applied by any suitable spray process. The outer layer 16 is preferably an MCrAlY alloy plus X additives, where M is a metal selected from Fe, Ni and/or Co, and where X is yttrium or another rare earth element. In an exemplary but non-limiting implementation, Cr is 10-25 wt. %; Al is 5-15 wt. %; X=0.1-8 wt. % and M is the balance of 0-65 wt. % of Co, 0-65 wt. % Ni and 0-65 wt. % Fe. The second layer is applied by a powder/wire spray process such as vacuum plasma, high velocity oxy-fuel, air plasma, arc wire spray, etc.

By providing a bilayer coating 12 with an inner PtAl (or PdAl) diffused layer 14, diffusion of aluminum from the outer protective layer 16 into the substrate 10 is slowed. By slowing the diffusion of aluminum into the substrate, the oxidation-resistant properties of the outer protective layer 16 are maintained over a longer period of time, thus increasing the life of the substrate (or a gas turbine component) 10.

It will be appreciated that the bilayer protective coating 12 of this invention may be applied to any nickel or cobalt-based superalloy turbine component that is exposed to the harsh conditions of the turbine hot gas path.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A turbine component having a protective bilayer coating thereon comprising:
a superalloy substrate; and
a bilayer protective coating applied to the substrate wherein the bilayer protective coating comprises a first inner layer of diffused platinum and aluminum; and
a second outer oxidation-resistant layer applied over said first inner layer, said second outer layer comprising an MCrAlX alloy where M is selected from Fe, Ni and Co, and X is selected from the rare earth elements.

2. The turbine component of claim 1 wherein said alloy substrate is composed of a nickel or cobalt-based superalloy.

3. The turbine component of claim 1 wherein said first inner layer comprises discrete platinum and aluminum components.

4. The turbine component of claim 2 wherein said first inner layer comprises discrete platinum and aluminum components.

5. The turbine component of claim 1 wherein said component comprises a hot gas path component of a gas turbine.

6. The turbine component of claim 1 wherein said first inner layer includes one or more oxidation enhancing elements.

7. A method of improving oxidation resistant properties of a Ni or Co-based superalloy turbine component comprising:
depositing a bilayer protective coating on a turbine component by producing a first inner platinum or palladium diffused aluminide layer on a surface of said turbine component; and
spraying a second outer layer comprising an MCrAlX alloy onto said first inner layer, wherein M is a metal selected from Fe, Ni and Co, and where X is selected from yttrium or another rare earth element.

8. The method of claim 7 wherein said first inner layer is produced in two discrete steps by first applying the platinum or palladium on said surface and then applying the aluminum.

9. The method of claim 7 wherein said platinum or palladium is deposited electroplating.

10. The method of claim 9 wherein said aluminum is applied by vapor phase deposition.

11. The method of claim 7 wherein said spraying comprises a powder/wire spray process selected from vacuum plasma, high velocity oxy-fuel, air plasma, and arc wire spray processes.

12. The method of claim 7 wherein said platinum or palladium is deposited by a paint or slurry process.

13. The method of claim 7 wherein said McrAlX alloy comprises 10-25 wt. % Cr, 5-15 wt. % Al; 0.1-8 wt. % X, and the balance M of 0-65 wt. % Co, Ni or Fe.
